(19) United States
(12) Patent Application Publication
(10) Pub. No.: US 2024/0124092 A1
(43) Pub. Date: Apr. 18, 2024

(54) VARIABLY DAMPED FLOW CONTROL SOLENOID

(71) Applicant: Fox Factory, Inc., Duluth, GA (US)

(72) Inventor: Andrew Laird, Los Gatos, CA (US)

(73) Assignee: Fox Factory, Inc., Duluth, GA (US)

(21) Appl. No.: 18/305,314

(22) Filed: Apr. 21, 2023

Related U.S. Application Data
(60) Provisional application No. 63/333,366, filed on Apr. 21, 2022.

(51) Int. Cl. B62K 25/04; F16F 9/348; F16K 31/06

(52) U.S. Cl. CPC B62K 25/04; F16F 9/348; F16K 31/0668; B62K 2025/044

(57) ABSTRACT

A variably damped flow control solenoid is disclosed herein. The variably damped flow control solenoid includes an armature with a flow path therethrough, a plate, and a pin coupled with the plate. The pin extending from the plate toward the armature. The pin configured to provide a controlled annular gap with respect to the flow path of the armature for a portion of travel of the armature. The shape of the pin configured to provide a variable axial dependent rate of velocity to the armature for the portion of travel of the armature.

### CROSS-REFERENCE TO RELATED APPLICATIONS

This application claims benefit of U.S. Provisional Patent Application Ser. No. 63/333,366, filed Apr. 21, 2022, entitled “VARIABLY DAMPED FLOW CONTROL SOLENOID” by Andrew Laird, assigned to the assignee of the present application, having Attorney Docket No. FOX-0183US.PRO, which is herein incorporated by reference in its entirety.

### FIELD OF THE INVENTION

Embodiments of the invention generally relate to a fluid flow control valve.

### BACKGROUND

Controlling the flow of fluid through a pathway is important in many types of systems. A shock assembly is one example of such a system and is used in numerous different vehicles and configurations to absorb some or all of a movement that is received at an unsprung portion of a vehicle before it is transmitted to a suspended portion of the vehicle. For example, when a wheel hits a pothole, the encounter will cause an impact force on the wheel. However, by utilizing suspension components including one or more shock assemblies, the impact force will be significantly reduced or even absorbed completely before it is transmitted to a handlebar, seat, pedal, foot peg, or the like.

It is valuable to be able to change one or more performance characteristics of the shock assembly for personal comfort, vehicle performance, and the like. A valve is often used to open, close, and/or modify the fluid pathway and change one or more of the performance characteristics.

### BRIEF DESCRIPTION OF THE DRAWINGS

Aspects of the present invention are illustrated by way of example, and not by way of limitation, in the accompanying drawings, wherein:

FIG. 1A is a perspective view of a bicycle having a plurality of electronically actuated components, in accordance with an embodiment.

FIG. 1B is a side view of the bicycle of FIG. 1A showing only some of the plurality of electronically actuated components, in accordance with an embodiment.

FIG. 2A is a perspective view of an adjustable shock assembly having an variably damped flow control solenoid, in accordance with an embodiment.

FIG. 2B is a side view of the adjustable shock assembly with a variably damped flow control solenoid including a cutaway portion of a reservoir, shown in accordance with one embodiment is shown in accordance with an embodiment.

FIG. 3 is a side section view of a variably damped flow control solenoid with a metered orifice, in accordance with an embodiment.

FIG. 4A is a side section view of the armature and pin-and-plate portion of the variably damped flow control solenoid, shown in accordance with an embodiment.

FIG. 4B is a perspective section view of the armature and pin-and-plate portion of the variably damped flow control solenoid, shown in accordance with an embodiment.

FIG. 5 is a perspective view of the armature of the variably damped flow control solenoid, shown in accordance with an embodiment.

FIG. 6 is a perspective view of the pin-and-plate of the variably damped flow control solenoid, shown in accordance with an embodiment.

FIG. 7 is another perspective view of the pin-and-plate of the variably damped flow control solenoid, shown in accordance with an embodiment.

FIG. 8 is side section view of the pin-and-plate of the variably damped flow control solenoid, shown in accordance with an embodiment.

FIG. 9 is a graph of the effective orifice diameter versus spool travel for the variably damped flow control solenoid, shown in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

In general, a suspension system for a vehicle provides a motion modifiable connection between a portion of the vehicle that is in contact with a surface (e.g., an unsprung portion) and some or all of the rest of the vehicle that is not in contact with the surface (e.g., a suspended portion). For example, the unsprung portion of the vehicle that is in contact with the surface will include one or more wheel(s), skis, tracks, hulls, etc., while some or all of the rest of the vehicle that is not in contact with the surface include suspended portions such as a frame, a seat, handlebars, engines, cranks, etc.

The suspension system will include one or numerous components which are used to couple the unsprung portion of the vehicle (e.g., wheels, skids, wings, etc.) with the suspended portion of the vehicle (e.g., seat, cockpit, passenger area, cargo area, etc.). Often, the suspension system will include one or more shock assemblies which are used to reduce feedback from the unsprung portion of the vehicle before that feedback is transferred to the suspended portion of the vehicle, as the vehicle traverses an environment. However, the language used by those of ordinary skill in the art to identify a shock assembly used by the suspension system will differ while referring to the same (or similar) types of components. For example, some of those of ordinary skill in the art will refer to the shock assembly as a shock absorber, while others of ordinary skill in the art will refer to the shock assembly as a damper (or damper assembly).

The shock assembly often consists of a (damping) piston and piston rod telescopically mounted in a fluid filled cylinder (e.g., a housing). The fluid (e.g., damping fluid, working fluid, etc.) is, for example, a hydraulic oil, a gas such as nitrogen, air, or the like. In one embodiment, the adjustable shock assembly will include a mechanical spring (e.g., a helically wound spring that surrounds or is mounted in parallel with the body of the adjustable shock assembly). In one embodiment, the adjustable shock assembly will include an air spring. In one embodiment, the adjustable shock assembly will include both a mechanical spring and an air spring.

As used herein, the terms “down”, “up”, “downward”, “upward”, “lower”, “upper”, and other directional references are relative and are used for reference and identification purposes.

In its basic form, the suspension is used to increase ride comfort, performance, endurance, component longevity and the like. In general, the force of jarring events, rattles, vibrations, jostles, and the like which are encountered by the portion of the vehicle that is in contact with the surface are reduced or even removed as it transitions through the suspension before reaching suspended portions of the vehicle to include components such as seats, steering wheels/handlebars, pedals/foot pegs, fasteners, drive trains, engines, and the like.

For example, on a wheeled vehicle, a portion of the wheel (or tire) will be in contact with the surface being traversed (e.g., pavement, dirt, gravel, sand, mud, rocks, etc.) while a shock assembly and/or other suspension system components will be coupled between a wheel retaining assembly and the suspended portion of the vehicle (often a portion of the vehicle frame and associated systems, the seat, handlebars, pedals, controls, steering wheel, interior, etc.).

In a snow machine, a portion of the track and/or the skis that will be in contact with the surface being traversed (e.g., snow, ice, etc.) while a shock assembly and/or other suspension components will be coupled between a track retaining assembly (and similarly the skis retaining assembly) and the suspended portion of the vehicle (usually including the engine and associated systems, the seat, handlebars, etc.).

In a boat or PWC vehicle, a portion of the hull will be in contact with the surface of the water while a shock assembly and/or other suspension components will be coupled between the hull and the suspended portion(s) of the vehicle (such as the seat, the handlebars, a portion of the vehicle frame, and/or the like).

In an airplane in flight, it is the airframe that is in contact with the surface being traversed (e.g., the air) while a shock assembly and/or other suspension components will be coupled between the airframe and the suspended portion(s) of the vehicle (such as the seats and the like).

In one embodiment, there are times where changes to the performance of a suspension component is desired during a given ride/drive. For example, a bike rider in a sprinting scenario would often want to firm up or possibly even lockout the suspension component to remove the opportunity for rider induced pedal bob. Similarly, a ride/drive from a paved road to an off-road environment (or vice-versa) would also be a time when a change to one or more suspension component settings is valuable.

With respect to the term lockout, for purposes of the following discussion, lockout refers to the most restricted flow state attainable or desirable. Thus, in one embodiment, lockout refers to a stoppage of all fluid flow through a given fluid path. However, in another embodiment, lockout does not stop all the fluid flow through a given fluid path. For example, a manufactured component may not be able to stop all fluid flow due to tolerances, or a manufacturer (designer, etc.) may not want to stop all fluid flow for reasons such as lubrication, cooling, etc. Similarly, a lockout state is a “perceived lockout”; that is, the flow area through a flow path of the adjustable shock assembly has been reduced to a minimum size for a given adjustable shock assembly, machine, environment, speed, performance requirement, etc. For example, in one “perceived lockout” most, but not all, of the fluid flow is minimized while in another “perceived lockout” the fluid flow is reduced by only half (or a third, quarter, three-quarters, or the like).

The term “active”, as used when referring to a valve or shock assembly component, means adjustable, manipulatable, etc., during typical operation of the valve. For example, an active valve will have its operation changed to thereby alter a corresponding shock assembly characteristic damping from a “soft” setting to a “firm” setting (or a stiffness setting somewhere therebetween) by, for example, adjusting a switch in a passenger compartment of a vehicle. Additionally, it will be understood that in some embodiments, an active valve may also be configured to automatically adjust its operation, and corresponding shock assembly damping characteristics, based upon, for example, operational information pertaining to the vehicle and/or the suspension with which the valve is used.

Similarly, it will be understood that in some embodiments, an active valve is configured to automatically adjust its operation, and corresponding shock assembly damping characteristics, based upon received user input settings (e.g., a user-selected “comfort” setting, a user-selected “sport” setting, and the like). In many instances, an “active” valve is adjusted or manipulated electronically (e.g., using a powered solenoid, electric motor, poppet, or the like) to alter the operation or characteristics of a valve and/or other component. As a result, in the field of suspension components and valves, the terms “active”, “electronic”, “electronically controlled”, and the like, are often used interchangeably.

The term “manual” as used when referring to a valve or shock assembly component means manually adjustable, physically manipulatable, etc., without requiring disassembly of the valve, damping component, or shock assembly which includes the valve or damping component. In some instances, the manual adjustment or physical manipulation of the valve, damping component, or shock assembly which includes the valve or damping component, occurs when the valve is in use. For example, a manual valve is adjusted to change its operation to alter a corresponding shock assembly damping characteristic from a “soft” setting to a “firm” setting (or a stiffness setting somewhere therebetween) by, for example, manually rotating a knob, pushing or pulling a lever, physically manipulating an air pressure control feature, manually operating a cable assembly, physically engaging a hydraulic unit, and the like. For purposes of the present discussion, such instances of manual adjustment/physical manipulation of the valve or component will occur before, during, and/or after “typical operation of the vehicle”.

It should further be understood that a vehicle suspension may also be referred to using one or more of the terms “passive”, “active”, “semi-active” or “adaptive”. As is typically used in the suspension art, the term “active suspension” refers to a vehicle suspension which controls the vertical movement of the wheels relative to vehicle. Moreover, “active suspensions” are conventionally defined as either a “pure active suspension” or a “semi-active suspension” (a “semi-active suspension” is also sometimes referred to as an “adaptive suspension”). In a conventional “pure active suspension”, a motive source such as, for example, an actuator, is used to move (e.g. raise or lower) a wheel with respect to the vehicle. In a “semi-active suspension”, no motive force/actuator is employed to adjust move (e.g. raise or lower) a wheel with respect to the vehicle.

Rather, in a “semi-active suspension”, the characteristics of the suspension (e.g. the firmness of the suspension) are altered during typical use to accommodate conditions of the terrain and/or the vehicle. Additionally, the term “passive suspension”, refers to a vehicle suspension in which the characteristics of the suspension are not changeable during typical use, and no motive force/actuator is employed to adjust move (e.g. raise or lower) a wheel with respect to the vehicle. As such, it will be understood that an “active valve”, as defined above, is well suited for use in a “pure active suspension” or a “semi-active suspension”.

In the disclosed variably damped flow control solenoid, the motive component (e.g., solenoid, electric motor, stepper motor, or the like) will seat, unseat, or partially unseat an armature (e.g., valve needle, poppit, plug, etc.) with respect to a plate (e.g., valve seat, orifice, opening, pathway, etc.) having a pin coupled therewith. Thus, in one embodiment, when the variably damped flow control solenoid receives an input command, the motive component will adjust the position of the armature with respect to the plate and pin (which will cause the fluid pathway flow characteristics to change as the fluid pathway will be closed, opened, partially opened, or partially closed), thereby modifying one or more damping characteristics of the shock assembly.

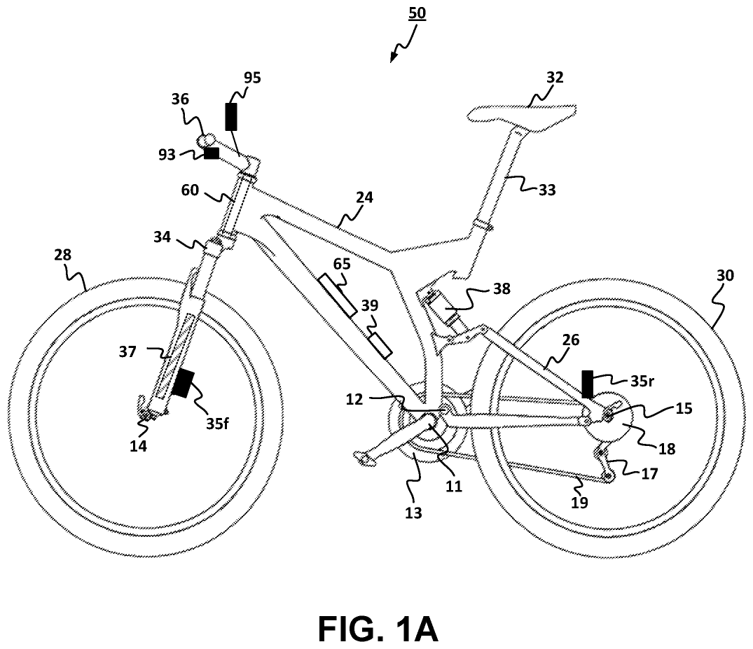

Referring now to FIG. 1A, a perspective view of a bicycle 50 having a plurality of electronically actuated components is shown in accordance with an embodiment. Although a bicycle is used in the discussion. In one embodiment, one or more of the electronically actuated components 75 (shown in FIG. 1B) are used on another vehicle such as, but not limited to a road bike, a mountain bike, a gravel bike, an electric bike (e-bike), a hybrid bike, a scooter, a motorcycle, an ATV, a personal water craft (PWC), a four-wheeled vehicle, a snow mobile, a UTV such as a side-by-side, and the like. In one embodiment, the electronically actuated components 75 are used on a suspension inclusive device such as, but not limited to an exoskeleton, a seat frame, a prosthetic, a suspended floor, and the like. However, in the following discussion, and for purposes of clarity, a bicycle is utilized as the example vehicle.

Thus, between the disclosed examples as provided in view of a bicycle 50, the disclosed embodiments will be used on electronically actuated components used by vehicles with wheels, skis, tracks, hulls, and/or with suspension inclusive devices such as prosthetic limbs, exoskeletons, and the like.

In one embodiment, bicycle 50 has a main frame 24 with a suspension system comprising a swing arm 26 that, in use, is able to move relative to the rest of main frame 24; this movement is permitted by, inter alia, rear shock assembly 38. The front fork 34 also provides a suspension function via a front shock assembly 37 in at least one fork leg; as such the bicycle 50 is a full suspension bicycle (such as an all-terrain bike (ATB), mountain bike, e-bike, etc.).

However, the embodiments described herein are not limited to use on full suspension bicycles. In particular, the term “suspension system” is intended to include vehicles having front suspension only, rear suspension only, seat suspension only, a combination of two or more different suspensions, and the like.

In one embodiment, swing arm 26 is pivotally attached to the main frame 24 at pivot point 12 which is located above the bottom bracket axis 11. Although pivot point 12 is shown in a specific location, it should be appreciated that pivot point 12 will be found at different distances from bottom bracket axis 11 depending upon the rear suspension configuration. The use of the specific pivot point 12 herein is provided merely for purposes of clarity. For example, in a hardtail bicycle embodiment, there would be no pivot point 12. In one embodiment of a hardtail bicycle, main frame 24 and swing arm 26 would be formed as a fixed frame. Bottom bracket axis 11 is the center of the pedal and front sprocket assembly 13. Bicycle 50 includes a front wheel 28, a rear wheel 30 and a seat 32. A seat 32 is connected to the main frame 24 via a dropper seatpost 33 in order to support a rider of the bicycle 50. In one embodiment, seatpost 33 used to adjustably retain and/or adjust the height of saddle 32 with respect to main frame 24, without modifying a yaw or a pitch position of saddle 32 with respect to main frame 24. In one embodiment, seatpost 33 is a dropper seatpost used to adjustably retain and/or adjust the height of saddle 32 with respect to main frame 24, and may also modify one or both of the yaw and pitch positions of saddle 32 with respect to main frame 24.

Front wheel 28 is coupled with the front fork 34 via axle 14. The front fork 34 includes a crown and at least one fork leg. Above the crown, a steerer tube 60 passes through a portion of bicycle main frame 24 and attaches the fork 34 to the handlebars 36 (via a stem) allowing the rider to steer the bicycle 50. In one embodiment, at least one active valve damper 37 is integrated with fork 34.

The rear wheel 30 is connected to the swing arm 26 of the main frame 24 at rear axle 15. A rear shock assembly 38 is positioned between the swing arm 26 and the main frame 24 to provide resistance to the pivoting motion of the swing arm 26 about pivot point 12. Thus, the illustrated bicycle 50 includes a suspension member between swing arm 26 and the main frame 24 which operate to substantially reduce rear wheel 30 impact forces from being transmitted to the seat 32, pedals, and/or handlebar 36 (and thus the rider) of the bicycle 50.

In one embodiment, saddle 32 is connected to the main frame 24 via seatpost 33. In one embodiment, front shock assembly 37, rear shock assembly 38, seatpost 33, handlebar 36, and/or the like include one or more active and/or semi-active damping components which are used to reduce an initial force generated by an event (e.g., imparted to a wheel of the vehicle from the surface on (or through) which the vehicle is traveling) to a lesser force as it is transferred to the rest of the vehicle and/or persons riding therein/thereon.

In one embodiment, bicycle 50 is driven by a chain 19 coupled with both front sprocket assembly 13 and rear sprocket 18. As the front sprocket assembly 13 is rotated about bottom bracket axis 11, a force is applied to chain 19 which transfers the energy from the front sprocket assembly 13 to rear sprocket 18. Chain tension device 17 provides a variable amount of tension on chain 19. The need for chain 19 length variation will be due to factors such as a number of different gears that are on one or both of front sprocket assembly 13 and/or rear sprocket 18 and/or changes in chain stay length as the distance between bottom bracket axis 11 (where front sprocket assembly 13 attaches to main frame 24) and the rear axle 15 changes due to suspension articulation.

In one embodiment, bicycle 50 includes a number of electronically actuated components 75 (identified in FIG. 1B) including one or more of: an active valve damper(s) (e.g., rear shock assembly 38, front shock assembly 37, a seat post damper, etc.), as well as other interactive components and features such as one or more of: a switch 93, a controller 39, a sensor(s) (e.g., sensor(s) 35f, 35r, and the like), a mobile device 95, a power source(s) 65, smart components, and the like.

In one embodiment, sensor 35r is positioned on the swing arm 26 the rear axle 15 of bicycle 50. In one embodiment, sensor 35f is positioned in an unsprung location of front fork 34.

Although a number of sensors are shown in accordance with one embodiment, in other embodiments, the same sensors (and/or additional sensors) are located in other locations, to sense and/or measure things such as temperature, voltage, current, resistance, noise, positions of one or more components of bicycle 50, such as seatpost 33, pedals, derailer, chain, lever locations, etc.

Additional information for vehicle suspension systems, sensors, and their components as well as adjustment, modification, and/or replacement aspects including manually, semi-actively, and/or actively controlled aspects and wired or wireless control thereof is provided in U.S. Pat. Nos. 8,838,335; 9,353,818; 9,682,604; 9,797,467; 10,036,443; 10,415,662; the content of which are incorporated by reference herein, in their entirety.

In one embodiment, one or a plurality of component(s) of the bicycle 50 are also smart component(s). Examples of the smart component(s) will include one or more of the forks, wheels, rear shocks, front shocks, handlebars, seat posts, pedals, cranks, and the like. In one embodiment, the smart component(s) will include connective features that allow them to communicate wired or wirelessly with one or more of the electronically actuated components 75 (of FIG. 1B), and/or any other smart component(s) within transmission range (thereby becoming connected components).

In one embodiment, data (including real-time data) is collected or provided from the smart component to the controller 39. Depending upon the connected component, data such as telemetry attributes to provide angle, orientation, velocity, acceleration, RPM, operating temperature, and the like, will be obtained.

Referring now to FIG. 1B, a schematic side view of a bicycle 50 with focus on the one or more of the electronically actuated components 75 is shown in accordance with an embodiment.

In one embodiment, one or more of the electronically actuated components 75 include one or more of: an active valve damper(s) (e.g., rear shock assembly 38, front shock assembly 37), seatpost 33, and the like, as well as other interactive components and features such as one or more of: a controller 39, one or more sensors (e.g., sensor 35f, 35r, and the like), hereinafter “sensor 35”, a switch 93, mobile device 95, power source 65, smart components, and the like.

In one embodiment, mobile device 95 is mounted to handlebar assembly 36 of bicycle 50. Although mobile device 95 is shown mounted to handlebar assembly 36, it should be appreciated that in another embodiment, the mobile device 95 is alternatively in a rider's backpack, pocket, or the like. In general, mobile device 95 is a smart device such as a mobile phone, tablet, a smart phone, a tablet, a smart watch, a piece of smart jewelry, smart glasses, or other user portable device(s) having wireless connectivity. Mobile device 95 is capable of broadcasting and receiving via at least one network, such as, but not limited to, WiFi, Cellular, Bluetooth, NFC, and the like. In one embodiment, mobile device 95 includes one or more of a display, a processor, memory, a location or position system, (such as a global positioning system (GPS), local positioning system, or the like), camera, and one or more sensors such as audio, visual, motion, acceleration, altitude, and the like.

In one embodiment, switch 93 is mounted to handlebar assembly 36 of bicycle 50. In one embodiment, switch 93 is a positional switch used in conjunction with one or more of the electronically actuated components 75.

In one embodiment, switch 93 is a multi-positional switch, an upshift/downshift type of switch, a button type switch, or the like. For example, switch 93 would be a 2-position switch, a 3-position switch, a switch that will cycle through a number of different modes (similar to a gear shift), or the like. Although switch 93 is shown mounted to handlebar assembly 36, it should be appreciated that in another embodiment, switch 93 is alternatively mounted in a different location on the vehicle, on a mount coupled to the vehicle, or the like. In one embodiment, the location of switch 93 is modifiable and is located on the vehicle based on a user's preference.

In general, sensor 35 is a single sensor (such as an accelerometer) or a combination of sensor types. Sensor 35 is used for sensing characteristics (or changes to characteristics) such as terrain, environment, temperature, vehicle speed, vehicle pitch, vehicle roll, vehicle yaw, component activity, or the like. It is understood that the one or more sensors are imbedded, moved, mounted, or the like, in any suitable configuration and allowing for any suitable range of adjustment as desirable.

In one embodiment, sensor 35 is a force or acceleration transducer (e.g., strain gage, Wheatstone bridge, accelerometer, hydraulic, interferometer based, optical, thermal or any suitable combination thereof). Further, the sensor 35 may utilize solid state electronics, electro-mechanical principles or MEMS, or any other suitable mechanisms.

Although a number of sensors are shown in FIGS. 1A and 1B, it should be appreciated that in another embodiment, there is only a single sensor or two or more sensors in operation. Moreover, in one embodiment, mobile device 95 is used as a sensor.

In general, the one or more sensors, suspension components, suspension component controller(s) and/or data processing system(s), and the like are coupled to and/or integrated with the vehicle structure, such as disclosed in U.S. Pat. Nos. 7,484,603; 8,838,335; 8,955,653; 9,303,712; 10,036,443; 10,060,499; 10,443,671; and 10,737,546; the content of which is incorporated by reference herein, in its entirety. Further, sensors and valves, or principles, of patents and other documents incorporated herein by reference, are integrated one or more embodiments hereof, individually or in combination.

In one embodiment, the sensor(s) 35 provides the obtained sensor data to controller 39. In one embodiment, controller 39 uses the sensor data to determine one or more adjustments of one or more of the electronically actuated components.

In one embodiment, controller 39 provides the one or more adjustments of one or more of the electronically actuated components as input to one or more of the electronically actuated components which then perform the one or more adjustments.

In one embodiment, controller 39 and/or any other controllers utilized by one or more components described herein are removably coupled with the component and as such, are removeable as a unit. In one embodiment, the controller 39 (or the like), once removed, will be coupled to a power source for charging purposes, if needed. Additionally, in one embodiment, the removed controller will, for example, download software or firmware upgrades. As a result, the rider/user obtains the advantage of having a controller which has the “latest and greatest” features available to the rider/user.

Although controller 39 is shown in a number of locations in FIGS. 1A and 1B, it should be appreciated that in other embodiments, controller 39 is located on the side of the frame, at the handlebars, under the saddle, carried by the rider if it is wireless, etc. The use of the mounting locations shown in FIGS. 1A and 1B are indicative of one embodiment, which is provided for purposes of clarity.

Similarly, although shown in certain locations in FIGS. 1A and 1B, in accordance with one embodiment, in other embodiments, one, some, or all of the components shown in FIGS. 1A and 1B are located in other locations. For example, one, some, or all of the components are located on the sides of components, at the handlebars, under the saddle, carried by the rider if it is wireless, located on a mount attached to a portion of the bicycle 50, etc. Thus, the use of the locations of components as shown in FIGS. 1A and 1B are indicative of one embodiment, which is provided for purposes of clarity.

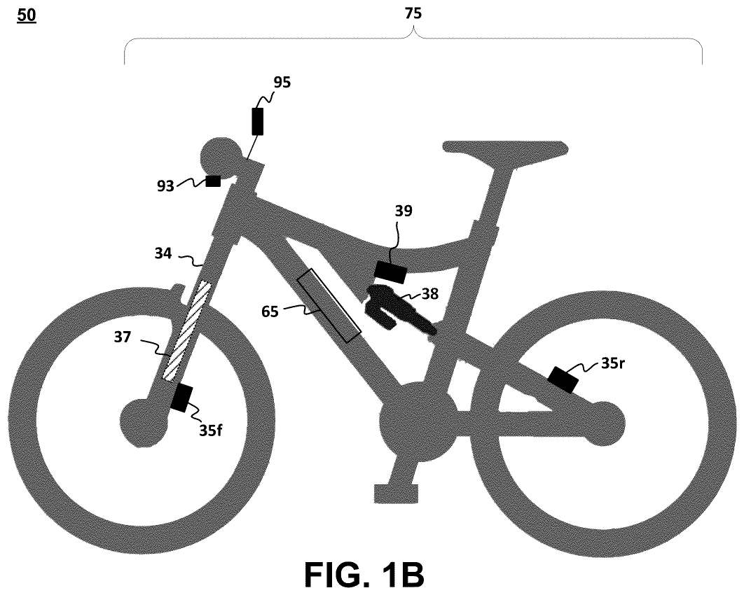

With reference now to FIG. 2A, a perspective view of an adjustable shock assembly is shown in accordance with one embodiment. In one embodiment, the adjustable shock assembly is a stand-alone fluid damper assembly, a coil sprung adjustable shock assembly, an air sprung fluid damper assembly, or the like. In its basic form, the adjustable shock assembly controls the speed of movement of a piston shaft by metering incompressible fluid from one side of the main piston to the other. In one embodiment, such as during a compression stroke, the adjustable shock assembly will also meter incompressible fluid from the main chamber to the reservoir 125, to account for the addition of the piston shaft volume as the piston shaft (coupled with the main piston) moves into the compression side of the main chamber and reduces the overall volume of the compression side of the main chamber. In one embodiment, such as during a rebound stroke, the adjustable shock assembly will also meter incompressible fluid from the reservoir 125 back to the main chamber to account for the overall volume change of the main chamber as the piston shaft (coupled with the main piston) moves out of the compression side of the main chamber.

In one embodiment, the adjustable shock assembly is the rear shock assembly 38. In one embodiment, the adjustable shock assembly will include a mechanical spring (e.g., a helically wound spring that surrounds or is mounted in parallel with the body of the adjustable shock assembly). In one embodiment, the adjustable shock assembly will include an air spring. In one embodiment, the adjustable shock assembly will include both a mechanical spring and an air spring.

In the following discussion, the operation of the variably damped flow control solenoid 300 is described in conjunction with the rear shock assembly 38. However, this is done for purposes of clarity. It should be appreciated that in some embodiments, some, most, or all, of the discussion of the variably damped flow control solenoid 300 is applicable to the front shock assembly 37, an exoskeleton, a seat frame of a vehicle, an adjustable shock assembly in a prosthetic appliance, or any other devices, vehicles, and the like, where a flow control valve is utilized.

In one embodiment, rear shock assembly 38 includes a top cap portion 100, shaft end eyelet 105, lower eyelet 110, damper body 120, air sleeve 123, and reservoir 125. In one embodiment reservoir 125 is an external or piggyback type of reservoir. In another embodiment, reservoir 125 is an internal reservoir. In one embodiment, the use of an external reservoir is provided merely for purposes of clarity in accordance with an embodiment. In one embodiment, rear shock assembly 38 may not include an external reservoir.

In one embodiment, rear shock assembly 38 includes one or more adjustable features such as, but not limited to, a pneumatic valve 130 (e.g., a Shrader valve, Presta valve, Dunlop valve, or the like), one or more of the variably damped flow control solenoids (such as those of adjustable active valve assembly 151, compression adjuster 161, and/or adjustable rebound valve assembly 171).

In one embodiment, the adjustable shock assembly may include fewer components, e.g., rear shock assembly 38 may not include most, some, or one of the top cap portion 100, shaft end eyelet 105, damper body 120, reservoir 125, pneumatic valve 130, and the one or more variably damped flow control solenoids.

As described herein, the variably damped flow control solenoid 300 includes a motive component (e.g., solenoid, electric motor, stepper motor, or the like) to seat, unseat, or partially unseat an armature (e.g., valve needle, poppit, plug, etc.) with respect to a plate (e.g., valve seat, orifice, opening, pathway, etc.). Thus, in one embodiment, when one or more of the variably damped flow control solenoids (such as those of adjustable active valve assembly 151, compression adjuster 161, and/or adjustable rebound valve assembly 171) of rear shock assembly 38 receive an input command, the input will cause a solenoid, electric motor, poppet, or the like to adjust one or more characteristics of one or more variably damped flow control solenoid(s) of the rear shock assembly 38.

In one embodiment, the input is received wired or wirelessly using communication devices and protocols. In one embodiment, the input is received from one or more of the controller(s) and component(s), such as, but not limited to controller 39, a controller coupled with another active shock assembly, another vehicles' controller 39, mobile device 95, another active shock assembly (e.g., front shock assembly 37), switch 93, sensor(s) 35, or the like.

In one embodiment, rear shock assembly 38 has a controller 39s coupled therewith. In one embodiment, controller 39s is similar in operation to the controller 39 described herein. In one embodiment, the input received by one or more of the variably damped flow control solenoid(s) of rear shock assembly 38 is received from controller 39s. In one embodiment, the input is received from one or more of the controller(s) and component(s), such as, but not limited to controller 39, controller 39s, a controller coupled with another active shock assembly, a controller and/or component associated with another vehicle and/or party, mobile device 95, switch 93, sensor(s) 35, or the like.

In one embodiment, the motive component (e.g., solenoid, electric motor, stepper motor, or the like) of the electronically adjustable component receives power from a power source such as those described in the power source discussion herein. In one embodiment, the power source (such as power source 65, power source 65s, or the like) is coupled with the electronically adjustable component of rear shock assembly 38.

In one embodiment, the power source 65s is integrated with the electronically adjustable component. In one embodiment, power source 65s is located separate from the electronically adjustable component. In one embodiment, rear shock assembly 38 includes both controller 39s and power source 65s. In one embodiment, the power source 65s is integrated with the controller 39s. In one embodiment, power source 65s is located separate from controller 39s.

In one embodiment, rear shock assembly 38 may include one or more sensors (such as sensors 35), in addition to controller 39s and/or power source 65s. In one embodiment, rear shock assembly 38 may include one or more sensors (such as sensors 35), in addition to controller 39s and power source 65s resulting in a fully self-contained active rear shock assembly 38.

Although components of FIG. 2A are shown in given locations in accordance with one embodiment, in other embodiments, one, some, or all of the components shown in FIG. 2A are located in other locations, one or more components are separated into two or more pieces and dispersed, etc. The use of the locations of the components as shown in FIG. 2A are indicative of one embodiment, which is provided for purposes of clarity.

With reference now to FIG. 2B, a side view of adjustable shock assembly 38 including a cutaway portion of reservoir 125 and a cutaway portion of variably damped flow control solenoid 300 is shown in accordance with one embodiment. For purposes of clarity, components of adjustable shock assembly 38 shown in FIG. 2B which are similar to those already discussed in FIG. 2A are not repeated. However, the discussion of FIG. 2A is incorporated by reference. In one embodiment, aspects, components, and views that are shown in more detail in FIG. 2B or include additional operational details will be discussed.

In one embodiment, the shaft-displaced fluid flow enters into reservoir 125 from variably damped flow control solenoid 300 as indicated by flow path arrow 251.

In one embodiment, reservoir 125 includes an internal floating piston (IFP) 126 that separates the working fluid in the reservoir 125 from an amount of pressurized gas. In general, the reservoir is used to store any shaft-displaced fluid due to a compression event that causes the piston shaft to move into the main chamber of shock assembly 38. For example, when the piston shaft moves into main chamber it reduces the volume available in the main chamber. Prior to the piston shaft incursion, that volume was used to contain the working fluid, during the piston shaft incursion, the reduced volume results in the displacement of the fluid from the main chamber to the reservoir 125 (i.e., shaft-displaced fluid). In one embodiment, fluid communication between the main chamber of shock assembly 38 and the reservoir 125 is via fluid flow pathways controlled by one (or more) variably damped flow control solenoid 300.

Additional descriptions and details of reservoir 125, including at least a reservoir housing and IFP 126, are described in U.S. Pat. No. 7,374,028 the content of which is incorporated by reference herein, in its entirety.

Although components of FIG. 2B are shown in given locations in accordance with one embodiment, in other embodiments, one, some, or all of the components shown in FIG. 2B are located in other locations, one or more components are separated into two or more pieces and dispersed, etc. The use of the locations of the components as shown in FIG. 2B are indicative of one embodiment, which is provided for purposes of clarity.

### Variably Damped Flow Control Solenoid

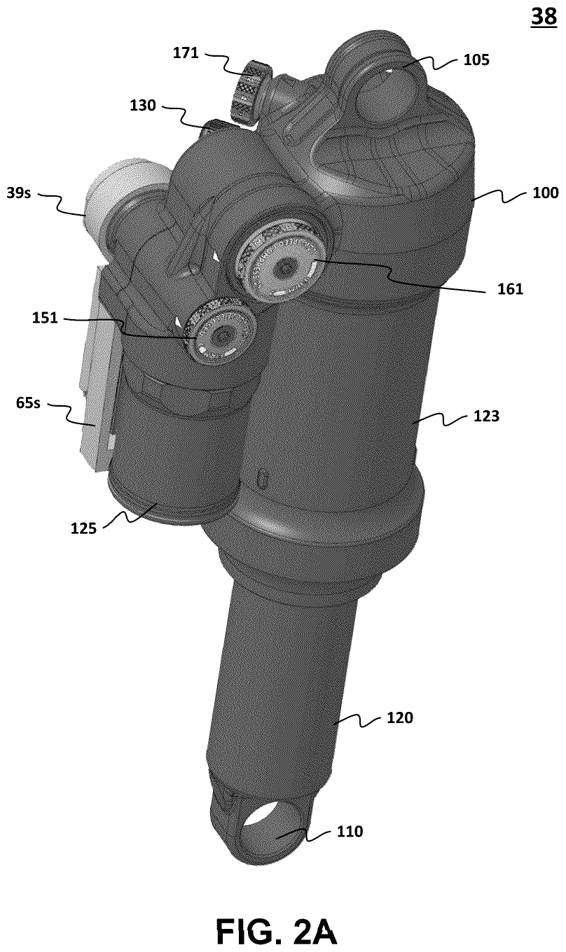

With reference now to FIG. 3, a side section view of a variably damped flow control solenoid 300 with a metered orifice is shown in accordance with an embodiment. In one embodiment, variably damped flow control solenoid 300 includes an armature 310 (with flow path 312) coupled to a drive feature, a motive component (e.g., a motor, actuator, solenoid, or the like-hereinafter motor), a plate 305 and a pin 315.

In one embodiment, the input from the motor into the drive feature will change the position of armature 310, e.g., seat or unseat the armature 310 (e.g., spool, needle, poppit, plug, etc.) with respect to a plate 305 (e.g., valve seat, orifice, etc.).

When variably damped flow control solenoid 300 is closed, armature 310 will be seated against plate 305 and pin 315 will be inserted within the flow path 312 of armature 310 such that flow path 312 is obstructed or closed.

In contrast, when variably damped flow control solenoid 300 is open, armature 310 will be separate from plate 305 and pin 315 such that flow path 312 will become unobstructed and open.

In general, pin 315 is provided to control the speed of the opening of armature 310. For example, when variably damped flow control solenoid 300 receives an open signal, armature 310 will begin to withdraw from its seat against plate 305. However, if the shock assembly 38, for example, is undergoing a compression event during the opening of the variably damped flow control solenoid 300 the fluid flow rate change during opening is significant.

Without pin 315, the high pressure within the closed flow path 312 of armature 310 due to the compression event will impart a significant change in the flow rate through armature 310 as fluid moves through the now open and unrestricted flow path 312 that has quickly changed from a high-pressure low-flow rate to a low-pressure high-flow rate. This sudden change will generate a pressure wave. This pressure wave is often loud enough to be heard by a user and will have a physical reverberation type event. In general, the pressure wave sound and physical reverberation heard and/or felt by the user would cause concern for operational error, broken components, or the like.

In contrast by providing pin 315 with plate 305, when variably damped flow control solenoid 300 receives an open signal during the compression event, armature 310 will begin to withdraw from its seat against plate 305. However, since pin 315 will still be partially impeding the fluid flow from flow path 312 of armature 310 as the armature 310 opens, the speed of the change from the high-pressure low-flow rate to the low-pressure high-flow rate through the now opening flow path 312 of armature 310 will be reduced as the fluid will have to move through the initially partially restricted annular region of flow path 312. Thus, by using the pin 315, as the armature 310 initially moves away from plate 305 the reduced speed of change will reduce and/or remove any pressure wave or the like caused by the fluid flowing through flow path 312 during the initial opening stage of the armature 310.

In one embodiment, by using pin 315 to meter the initial opening flow rate, the pressure wave is reduced and/or removed while battery life is comparatively increased. For example, assume the non-pin 315 armature opening takes 5 milliseconds and includes the pressure wave. One way to remove the pressure wave is to reduce the size of flow path 312. However, reducing the size of flow path 312 will also mean the armature opening will take 50 milliseconds. In contrast, by using pin 315, the pressure wave is removed while the size of flow path 312 is larger such that the opening of armature takes less than 50 milliseconds. Thus, by having shorter opening (and closing) times, the power required to move the armature will be reduced as the motor will be operated for shorter periods of time.

In one embodiment, the annular gap for the first part of the armature 310 travel (e.g., where the pin 315 is engaged with flow path 312) is approximately 0.020-.030 inches. Once the armature 310 has moved, in one example, more than about 0.030″, the pin 315 is no longer engaged in the flow path 312 and fluid will easily flow therethrough and allow the armature 310 to open to full travel (e.g., in one embodiment, about 0.060-0.100 inches) with no further damped restriction.

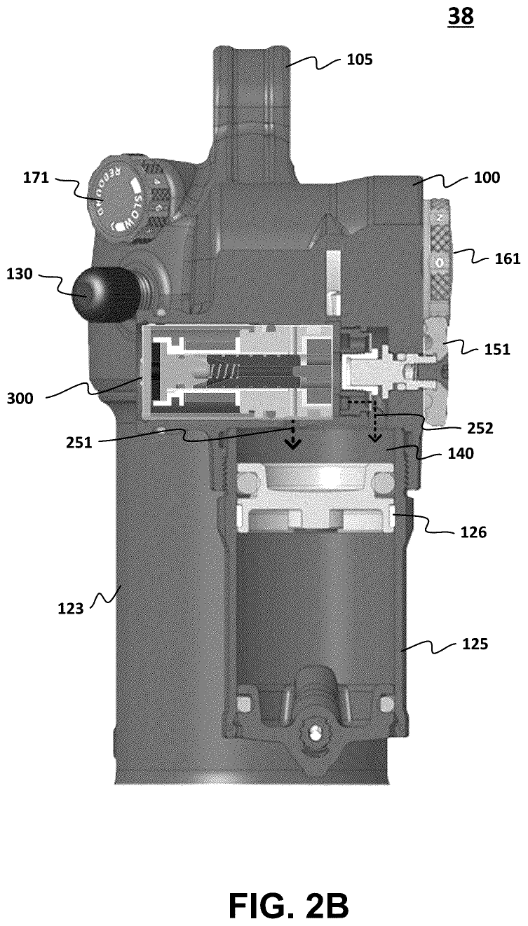

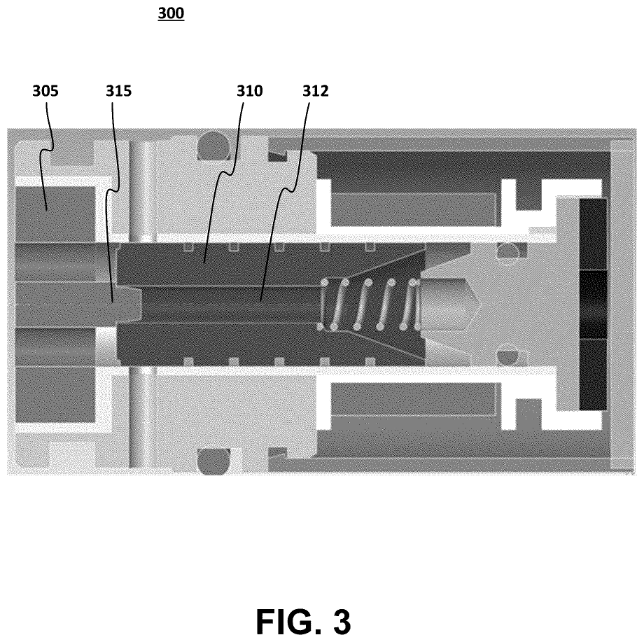

Referring now to FIG. 4A, a side section view of the armature 310 and pin-and-plate 305 portion of the variably damped flow control solenoid 300 is shown in accordance with an embodiment. FIG. 4B is a perspective section view of the armature 310 and pin-and-plate 305 portion of the variably damped flow control solenoid 300 shown in accordance with an embodiment. FIG. 5, a perspective view of the armature 310 of the variably damped flow control solenoid 300 is shown in accordance with an embodiment.

As shown in FIGS. 4A, 4B, and 5 in one embodiment, the armature 310 includes at least one protrusion 313 extending toward plate 305. In one embodiment, a plurality of protrusions 313 are extending toward plate 305. In one embodiment, protrusion(s) 313 is configured to surround pin 315 and contact plate 305 when variably damped flow control solenoid 300 is closed. In one embodiment, protrusion 313 allows for a reduction of the contact area between the armature 310 and the plate 305 and, as such, a minimization of pressure imbalances. In other words, the protrusion 313 allows a slight amount of leakage between the armature 310 and plate 305. In so doing, as pressure builds upstream of the variably damped flow control solenoid 300, the pressure will be fed into the internal chamber of the solenoid through the flow path 312 to keep it pressure balanced. Moreover, the slight amount of leakage allows fluid to escape during the opening of the armature 310 so no suction effect is created.

In one embodiment, protrusion 313 is a circular shape. In another embodiment, protrusion 313 is a different shape such as a trapezoidal, triangular, square, curved, or the like.

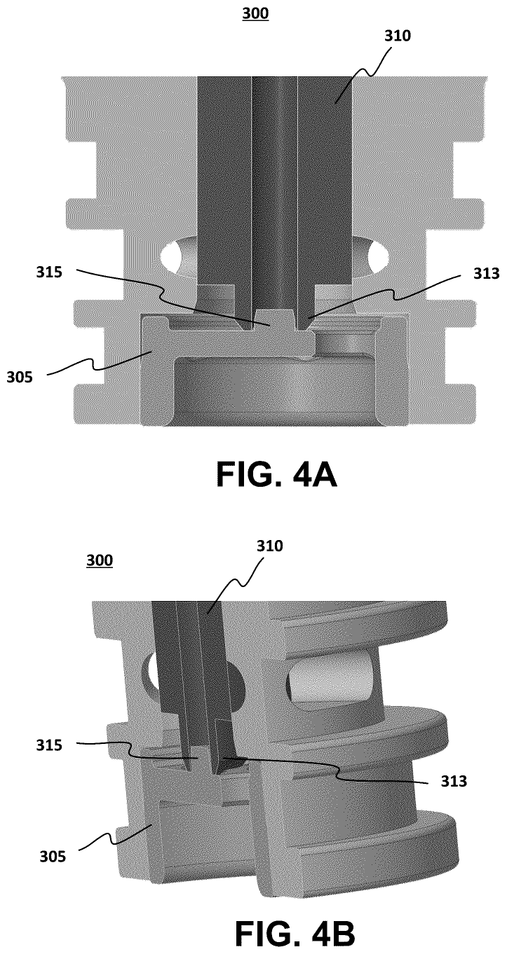

With reference now to FIG. 6, a perspective view of the pin 315 and plate 305 of the variably damped flow control solenoid 300 is shown in accordance with an embodiment. In one embodiment, pin 315 sticks up from the plate 305 surface approximately 0.020-.030 inches. In one embodiment, pin 315 is a circular shape with a constant radius. In another embodiment, pin 315 is a circular shape with a changing radius. For example, the base of pin 315 (flush with plate 305 would have a larger radius than the tip of pin 315. In one embodiment, pin 315 would have a different shape such as a trapezoid, cone, curve, or the like.

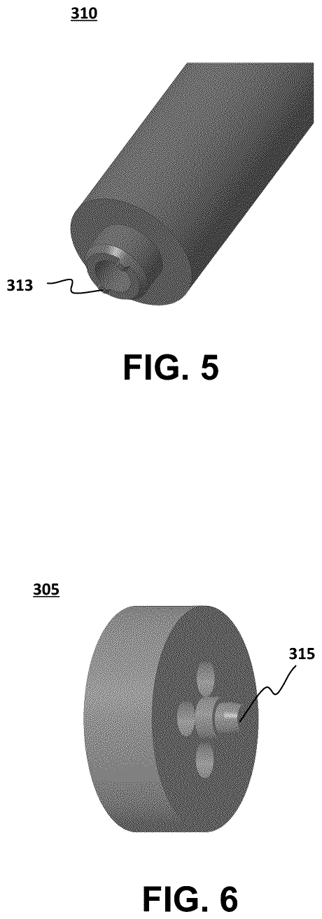

Referring now to FIG. 7, another perspective view of the pin 315 and plate 305 of the variably damped flow control solenoid 300 is shown in accordance with an embodiment. In one embodiment, plate 305 will have at least one hole 320 to allow a fluid flow therethrough. In one embodiment, plate 305 will have a plurality of holes 320 therethrough. In one embodiment, the plurality of holes 320 will have a uniform shape. In one embodiment, the plurality of holes 320 will be uniformly distributed about plate 305. In one embodiment, the plurality of holes 320 will include various shapes and/or a various distribution about plate 305.

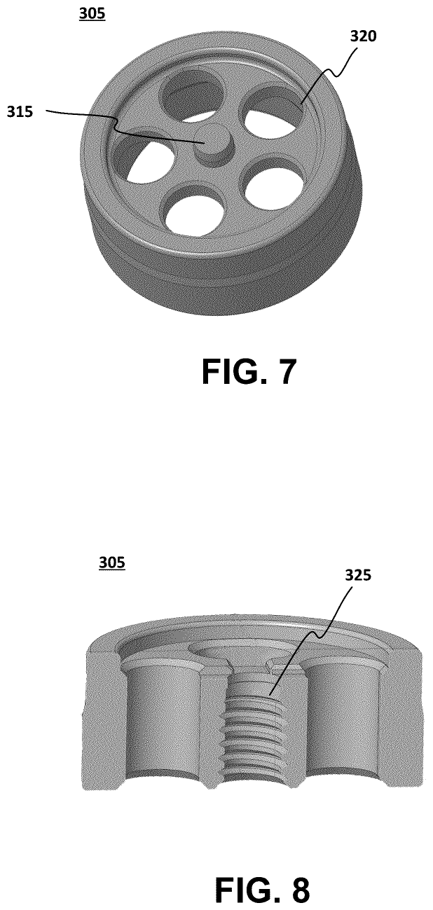

With reference now to FIG. 8, a side section view of the pin 315 and plate 305 of the variably damped flow control solenoid 300 is shown in accordance with an embodiment. In one embodiment, plate 305 includes an opening 325 within which pin 315 will be adjustably inserted. For example, in one embodiment, opening 325 is threaded and pin 315 is also threaded such that the pin 315 diameter and/or engagement length is adjustable. In one embodiment, pin 315 is spring loaded within opening 325 such that damping between the pin 315 and flow path 312 only occurs during opening (e.g., in the opening direction). In one embodiment, having an adjustably insertable pin 315 allows for maintenance and/or adjustment of the variably damped flow control solenoid 300 performance.

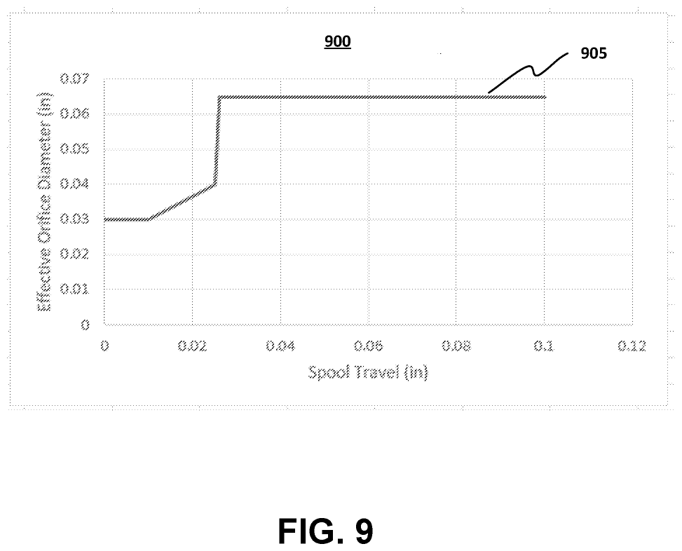

Referring now to FIG. 9, a graph 900 of the effective orifice diameter (e.g., flow path 312) versus spool (e.g., armature 310) travel for the variably damped flow control solenoid 300 is shown in accordance with an embodiment.

In one embodiment, the variably damped flow control solenoid 300 will receive one or more adjustment inputs. The one or more adjustment inputs will cause the variably damped flow control solenoid 300 to adjust the position of the armature 310 with respect to the plate 305 (which will cause the fluid pathway flow characteristics to change as the fluid pathway will be closed, opened, partially opened, or partially closed), thereby modifying one or more damping characteristics of shock assembly 38.

In one embodiment, the adjustment inputs are received via a wired or wireless electronic communication from one or more devices such as, but not limited to, controller 39, switch 93 (or the like), mobile device 95 (e.g., a laptop, tablet, computer, smart watch, smart jewelry), sensor 35, or the like. In one embodiment, the device providing the adjustment input is integrated with shock assembly 38.

When the variably damped flow control solenoid 300 is in a closed configuration, the armature 310 is seated against the plate 305 such that the fluid flow through the adjustable active valve 300 would be in its most restricted flow state. In so doing, a substantial volume (e.g., a preponderance, majority, most, all, etc.) of the fluid flowing through adjustable active valve assembly 151 would be flowing through a parallel flow path 252 instead of through variably damped flow control solenoid 300.

In contrast, when the variably damped flow control solenoid 300 is in a fully (or nearly fully) open configuration, armature 310 is moved its furthest distance away from plate 305 and a substantial volume (e.g., most, a preponderance, a majority, or possibly all) of the fluid that flows through adjustable active valve assembly 151 is able to flow through the variably damped flow control solenoid 300 to flow path 251 and, as such, may not require the use of the parallel flow path 252.

In one embodiment, variably damped flow control solenoid 300 only has a closed position and a full-open (or nearly full-open) position.

In one embodiment, variably damped flow control solenoid 300 will include a number of positions including the closed position and the full-open (or nearly full-open) position. In general, by adjusting the distance between the armature 310 and the plate 305, the percentage of the fluid flow rate that will flow through the variably damped flow control solenoid 300 to flow path 251 and thereby bypass the parallel flow path 252 is also adjustable.

In one embodiment, there are a predefined number of positions of armature 310, e.g., closed, half-open, fully open (or nearly full-open). In such an embodiment, the position of armature 310 with respect to the plate 305 will selectively be: fully seated (closed), halfway or partially unseated (partially open), or fully unseated (full-open or nearly full-open).

In one embodiment, the variably damped flow control solenoid 300 is infinitely adjustable. That is, the distance between the armature 310 and the plate 305 will be adjusted to any point between the closed (or minimum flow rate) position and the full-open (or nearly full-open) position. In so doing, the percentage of the fluid flow rate that flows through the variably damped flow control solenoid 300 to flow path 251 and the parallel flow path 252 will be infinitely adjusted thereby providing nuanced adjustment capabilities of the damping characteristics of shock assembly 38. In one embodiment, variably damped flow control solenoid 300 (or one or more components thereof) will be adjusted by inputs received via electronic transmission generated by the controller 39, sensor 35, and/or other electronic devices.

In one embodiment, the fixed size of the flow path(s) and openings (e.g., orifice openings) of the variably damped flow control solenoid 300 provide a high fluid flow rate without causing an excessive pressure drop. In other words, when completely opened, the variably damped flow control solenoid 300 to flow path 251 is capable of supporting the flow of a substantial volume (e.g., all, most, a preponderance, etc.) of the fluid passing through variably damped flow control solenoid 300 such that no pressure drop is built (or occurs), while also providing a complete (or nearly complete) bypass around the parallel flow path 252.

For example, when variably damped flow control solenoid 300 is fully open (or nearly fully-open), displaced fluid flows from the main chamber into adjustable active valve assembly 151 where the full (or nearly full) flow (or in other embodiments, more than three-quarters of the flow, more than two-thirds of the flow, or the like.) of the fluid is able to pass through the variably damped flow control solenoid 300 to flow path 251 and continue into the reservoir 125. Thus, when variably damped flow control solenoid 300 is in the fully open (or nearly fully-open) state, there is a reduced amount (e.g., little or no) of restriction to the fluid flow as it moves through flow path 251.

In contrast, when variably damped flow control solenoid 300 is closed, displaced fluid still flows from the main chamber 121 and into adjustable active valve assembly 151. However, at variably damped flow control solenoid 300, the fluid is substantially blocked from flowing through flow path 251 and instead has to pass through the parallel flow path 252 (such as a firmer blowoff stack circuit) before continuing into the reservoir 125.

The substantially closed (or partially closed) armature 310 will impede or slow the total amount of fluid flowing through variably damped flow control solenoid 300 thereby reducing the amount of shaft-displaced fluid that is exiting the main chamber through fluid pathway 251. This reduction in the amount of shaft-displaced fluid exiting the main chamber (for a given pressure) will slow the movement of the main piston into the main chamber. However, while the movement of the main piston is slowed, it is still in compression and still moving. As such, the pressure being applied to the fluid by the increasing volume of the shaft as it continues to move into the main chamber will increase. The increased pressure on the fluid in the main chamber will increase the pressure that the shaft-displaced fluid is applying to the firmer blowoff stack circuit of adjustable active valve assembly 151 which will allow more fluid to pass therethrough. In so doing, the compression damping firmness of shock assembly 38 will be increased.

Similarly, when the variably damped flow control solenoid 300 is moved from a substantially closed (or partially closed) state to an opened (or partially opened) state, the amount of fluid that will flow through variably damped flow control solenoid 300 over a given time period (for a given pressure) will increase (as more fluid will bypass the firmer blowoff stack circuit). This will result in an increase in the amount of shaft-displaced fluid that is able to exit the main chamber through fluid pathway 251 (for a given pressure) which will allow the main piston and shaft to more easily move into the main chamber as the fluid pressure caused by the increasing volume of the shaft as it continues to move into the main chamber will have been reduced. In so doing, the compression damping firmness of shock assembly 38 will be decreased. A similar operation may be used to control the rebound operations.

In one embodiment, variably damped flow control solenoid 300 receives its power from an external power source such as power source 65, power source 65s, or the like. In one embodiment, the power source 65s is integrated with the variably damped flow control solenoid 300. In one embodiment, power source 65s is located separate from variably damped flow control solenoid 300. In one embodiment, the power source is comprised of a power station or power pack. In one embodiment, the power source is a rechargeable battery. In one embodiment, the power source is a non-rechargeable battery such as, but not limited to, one or more of a CR2032 battery, a double A battery, a triple A battery, a lithium coin cell battery, a silver oxide cell battery, or the like.

Further discussion and examples of flow control solenoid operations are described in U.S. patent application Ser. No. 17/591,392, the content of which are incorporated by reference herein, in its entirety.

Thus, the electromagnetic (or electromechanical) solenoid has a variable, axial dependent rate of damping (or velocity) to its opening or closing behavior. In one embodiment, the variable, axial dependent rate of damping (or velocity) is controlled mathematically by the shape, size, length, of the pin 315 in conjunction with the armature 310 orifice (e.g., flow path 312) size as opposed to controlling the opening or closing speed of the armature 310 with only the motor.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments will be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A variably damped flow control solenoid comprising:
an armature with a flow path therethrough;
a plate; and
a pin coupled with said plate, said pin extends from said plate toward said armature, said pin configured to provide a controlled annular gap with respect to said flow path of said armature for a portion of travel of said armature, said shape of said pin configured to provide a variable axial dependent rate of velocity to said armature for said portion of travel of said armature.

2. The variably damped flow control solenoid of claim 1, wherein said portion of travel of said armature is an opening of said armature.

3. The variably damped flow control solenoid of claim 1, wherein said portion of travel of said armature is a closing of said armature.

4. The variably damped flow control solenoid of claim 1, wherein said portion of travel of said armature is 0.020-.030 inches.

5. The variably damped flow control solenoid of claim 1, wherein a full travel distance of said armature is 0.060-0.100 inches.

6. The variably damped flow control solenoid of claim 1, wherein said shape of said pin is circular with an axially changing radius.

7. The variably damped flow control solenoid of claim 1, wherein said armature further comprises:
at least one protrusion extending axially toward said plate, said at least one protrusion configured to reduce a contact area between said armature and said plate and provide an amount of leakage between said armature and said plate.

8. The variably damped flow control solenoid of claim 7, wherein said shape of said at least one protrusion is selected from a group consisting of: a trapezoid, a triangle, a square, and a curve.

9. The variably damped flow control solenoid of claim 1, wherein said plate further comprises:
an opening therein to adjustably retain said pin.

10. The variably damped flow control solenoid of claim 9, wherein said pin is spring loaded within said opening such that damping between said pin and said flow path only occurs in an opening direction.

11. The variably damped flow control solenoid of claim 1, wherein said plate further comprises:
at least one opening therethrough, said at least one opening configured to allow a fluid to flow therethrough.

12. A variably damped flow control solenoid comprising:
an armature with a flow path therethrough;
a motive component configured to change a position of said armature;
a plate; and
a pin coupled with said plate, said pin extends from said plate toward said armature, said pin configured to provide a controlled annular gap with respect to said flow path of said armature for a portion of travel of said armature, said shape of said pin configured to provide a variable axial dependent rate of velocity to said armature for said portion of travel of said armature.

13. The variably damped flow control solenoid of claim 12, wherein said portion of travel of said armature is a first 0.020-.030 inches of an opening of said armature.

14. The variably damped flow control solenoid of claim 12, wherein said portion of travel of said armature is a last 0.020-.030 inches of a closing of said armature.

15. The variably damped flow control solenoid of claim 12, wherein said shape of said pin includes a size and a length of said pin calculated with respect to a size and a shape of said flow path of said armature.

16. The variably damped flow control solenoid of claim 12, wherein said armature further comprises:
at least one protrusion extending axially toward said plate, said at least one protrusion configured to reduce a contact area between said armature and said plate and provide an amount of leakage between said armature and said plate.

17. The variably damped flow control solenoid of claim 16, wherein said shape of said at least one protrusion is selected from a group consisting of: a trapezoid, a triangle, a square, and a curve.

18. The variably damped flow control solenoid of claim 12, wherein said plate further comprises:
an opening therein to adjustably retain said pin.

19. The variably damped flow control solenoid of claim 18, wherein said pin is spring loaded within said opening such that damping between said pin and said flow path only occurs in an opening direction.

20. The variably damped flow control solenoid of claim 12, wherein said plate further comprises:
at least one opening therethrough, said at least one opening configured to allow a fluid to flow therethrough.

21. A variably damped flow control solenoid comprising:
an armature with a flow path therethrough;
a plurality of protrusions extending axially from said armature, said plurality of protrusions configured to reduce a contact area between said armature and a plate and provide an amount of leakage between said armature and said plate;
a motive component configured to change a position of said armature;
said plate; and
a pin coupled with said plate, said pin extends from said plate toward said armature, said pin configured to provide a controlled annular gap with respect to said flow path of said armature for a portion of travel of said armature, said shape of said pin configured to provide a variable axial dependent rate of velocity to said armature for said portion of travel of said armature.

22. A suspension comprising:
at least one shock assembly comprising:
a housing comprising a main chamber with a working fluid therein;
a main piston coupled with a piston shaft, said main piston within said main chamber;
a reservoir;
a fluid pathway fluidly coupling said main chamber with said reservoir; and
a variable damped flow control solenoid fluidly coupled with said fluid pathway, said variable damped flow control solenoid comprising:
an armature with a flow path therethrough;
a plate; and
a pin coupled with said plate, said pin extends from said plate toward said armature, said pin configured to provide a controlled annular gap with respect to said flow path of said armature for a portion of travel of said armature, said shape of said pin configured to provide a variable axial dependent rate of velocity to said armature for said portion of travel of said armature.

23. The suspension of claim 22, wherein said portion of travel of said armature is an opening of said armature.

24. The suspension of claim 22, wherein said portion of travel of said armature is a closing of said armature.

25. The suspension of claim 22, wherein said portion of travel of said armature is 0.020-0.030 inches.

26. The suspension of claim 22, wherein a full travel distance of said armature is 0.060-0.100 inches.

27. The suspension of claim 22, wherein said shape of said pin is circular with an axially changing radius.

28. The suspension of claim 22, wherein said armature further comprises:
at least one protrusion extending axially toward said plate, said at least one protrusion configured to reduce a contact area between said armature and said plate and provide an amount of leakage between said armature and said plate.

29. The suspension of claim 28, wherein said shape of said at least one protrusion is selected from a group consisting of: a trapezoid, a triangle, a square, and a curve.

30. The suspension of claim 22, wherein said plate further comprises:
an opening therein to adjustably retain said pin.

31. The suspension of claim 30, wherein said pin is spring loaded within said opening such that damping between said pin and said flow path only occurs in an opening direction.

32. The suspension of claim 22, wherein said plate further comprises:
at least one opening therethrough, said at least one opening configured to allow a fluid to flow therethrough.
